(19) United States
(12) Patent Application Publication
(10) Pub. No.: US 2003/0008102 A1
(43) Pub. Date: Jan. 9, 2003

(54) Insulating duct

(76) Inventors: Wolfgang Berl, Klettgau (DE); Armin Piur, Spreitenbach (CH); Daniel Schulz, Kilchberg (CH)

Correspondence Address: BURNS DOANE SWECKER & MATHIS L L P, POST OFFICE BOX 1404, ALEXANDRIA, VA, 22313-1404, US

(21) Appl. No.: 09/908,684

(22) Filed: Jul. 20, 2001

(30) Foreign Application Priority Data
Aug. 2, 2000 (EP) 00810697.3

(51) Int. Cl. B32B 3/26

(52) U.S. Cl. 428/119

(57) ABSTRACT

The insulating duct (6) is formed by a material which is built up in layers and is shaped in the manner of an L. The base of the L, which serves as the duct bottom (8), is of rigid design, whereas that limb of the L which serves as the duct wall (11) is of flexible design. A reinforcing insert (12, 13) is placed into the duct bottom (10, 11) and is guided into that part of the duct wall (10, 11) which adjoins the duct bottom (7, 8). In a U-shaped slot-insulating means formed from two of these insulating ducts (6) the radii located at the transitions between the base and the limbs of the U then exhibit great strength. During operation of a rotating, electrical machine into whose rotor a slot-insulating means produced in such a manner has been inserted, migration of the slot-insulating means because of centrifugal forces is very reliably avoided.

### TECHNICAL FIELD

The starting point of the invention is an insulating duct made of a material which is built up in layers and is shaped in the manner of an L in accordance with the preamble of patent claim 1. An L-shaped insulating duct of this type can be inserted together with a further L-shaped insulating duct, forming a U-shaped insulating duct, into a slot of a rotor of a rotating, electrical machine, for example a generator. The U-shaped insulating duct, which acts as a slot-insulating means, insulates an electrical conductor which is subsequently inserted into the slot from the rotor which is connected to ground. Materials used for the insulating duct include flexible synthetic papers, preferably based on polyamides, for example papers as sold under the trade name Nomex®, glass fibers, epoxy resins, polyimide films, for example as commercially available under the trade name Kapton®, and also polyester film. These materials are used individually, if appropriate, but preferably in combination with one or more of the abovementioned materials. In addition to these many combinations of materials, the ducts differ quite substantially in mass, depending on the geometrical dimensions of the slot. Insulating ducts having a very wide variety of slot shapes and combinations of materials can therefore be found on the market.

The manufacturers of slot-insulating means produce the ducts in a precisely fitting manner, corresponding to the slot geometry. The multiplicity of slot geometries requires a large number of pressing molds. A dedicated mold usually has to be produced for each geometry. The mold costs are irrelevant with regard to standardized rotors manufactured on a large scale. However, in the case of small series the costs of the pressing molds can play a decisive role. Particularly at the repairers, i.e. where rotors are removed and re-insulated within a short time, the mold costs and particularly the delivery time play a quite crucial role. The slot geometries are often not known to the contractor (foreign product, old machine etc.) and consequently can only be determined after the removal of the copper conductors. However, the insulating ducts which produce the slot-insulating means are the first things that have to be installed into the machine being repaired. It is therefore important that the insulating ducts required for the desired slot-insulating means are rapidly available.

### PRIOR ART

An insulating duct of L-shaped design in accordance with the preamble of patent claim 1 is described, for example, in DE 196 10 236 A1. A slot-insulating means formed from two such insulating ducts has an essentially U-shaped cross section. The limbs of the U are formed by those two limbs of the two insulating ducts which are each joined on to the base of the L and are guided upward. In contrast, the base of the U is formed by the two overlapping base sections of the two insulating ducts. Flexible synthetic papers or fiber-reinforced synthetic laminates are used as the material for the insulating ducts. The width of the base sections of the two insulating ducts is determined by the width of the slot-insulating means. Consequently, first of all slot ducts having an appropriately dimensioned width of the base sections are produced and the base sections are ground down in order thus to obtain, when installed into the slot, a uniformly thick and virtually cavity-free slot-insulating means. However, a slot-insulating means of this type is relatively complicated.

### SUMMARY OF THE INVENTION

The invention, as defined in the patent claims, is based on the object of specifying an insulating duct of the type mentioned in the introduction with which slot-insulating means of virtually any desired geometry can be produced in an economically favorable manner and which have sufficiently good mechanical and dielectric properties for most applications.

In the case of the insulating duct according to the invention, the base of the L, which serves as the duct bottom, is rigid and that limb of the L which serves as the duct wall is of flexible design, and a reinforcing insert is placed into the duct bottom and is guided into that part of the duct wall which adjoins the duct bottom. Then, from two of these insulating ducts a slot-insulating means having good mechanical and electric properties can be formed in an extremely cost-efficient manner by simple insertion of these two into a slot. The slot-insulating means has a rigid duct bottom which rests on the base of the slot and duct walls which are of flexible design and can therefore be readily formed and can be adapted to virtually any desired slot shape, irrespective of whether it is of angled or stepped design. In this connection, it is favorable in production terms that the width of the bottoms of the insulating ducts can be cut to the slot width, for example by sawing, cutting or punching, prior to insertion into the slot. A multiplicity of slot-insulating means having different widths and different profiles can thus be produced from insulating ducts which are of identical design and have been produced in just one single pressing mold. It is particularly advantageous here that the insert is guided into that part of the duct wall which adjoins the duct bottom. In the U-shaped slot-insulating means which is formed from two of these insulating ducts, the radii which are located at the transitions between the base and the limbs of the U then exhibit great strength. During operation of a rotating, electrical machine into whose rotor a slot-insulating means manufactured in such a manner has been inserted, migration of the slot-insulation means because of centrifugal forces is therefore very reliably avoided.

From a manufacturing and dielectric point of view, it has proven particularly advantageous that the material of the insulating ducts comprises at least two layers which are made of flexible insulating material, are provided in the duct bottom and in the duct wall and between which the insert reinforcing the layers is provided in the duct bottom.

If an insert which is made of flexible insulating material and adjoins the reinforcing insert is provided in the duct wall, a slot-insulating means produced from these two insulating ducts is distinguished by particularly advantageous dielectric performance. The dielectric performance can additionally also be improved if a further layer which is made of flexible insulating material of an electrically superior, but mechanically less highly stressable material is provided between the at least two layers made of flexible insulating material.

### BRIEF DESCRIPTION OF THE DRAWINGS

A preferred exemplary embodiment of the invention and the other advantages which can be obtained therewith are explained in greater detail below with reference to the drawings, in which:

FIG. 1 shows an aspect of a section transverse to a slot through a part of a rotor of a rotating, electrical machine, which part contains the slot, a slot-insulating means and an electrical conductor, and

FIG. 2 shows an aspect of a section transverse to the slot through an insulating duct according to the invention, which insulating duct is provided in the slot-insulating means according to FIG. 1 and is of L-shaped design.

### WAY OF IMPLEMENTING THE INVENTION

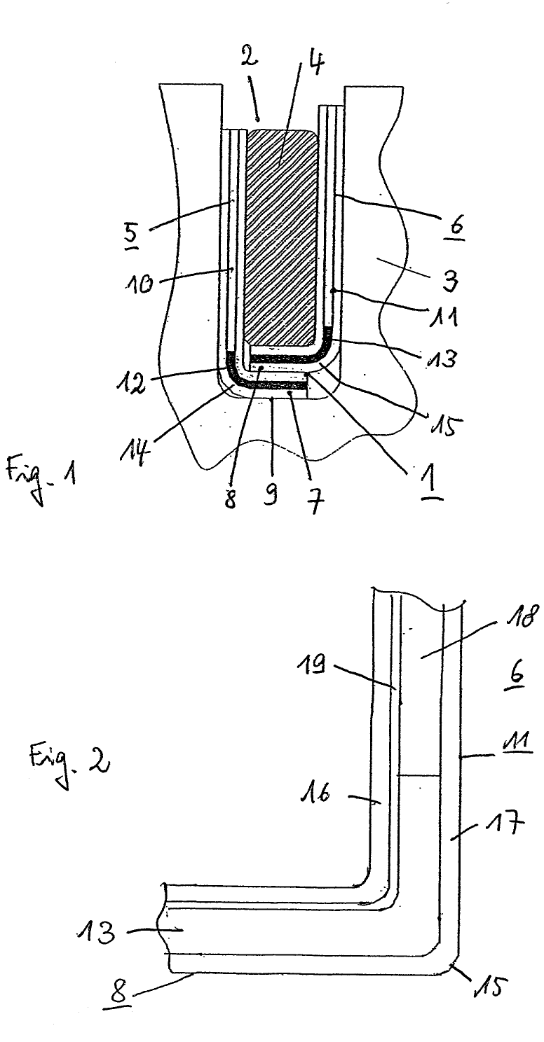

In the figures, the same reference numbers refer to identically acting parts. In FIG. 1, 1 denotes a slot-insulating means of U-shaped cross section which is inserted in a slot 2 of a metal rotor 3 of a rotating, electrical machine, for example a high-current generator. The slot-insulating means 1 insulates a current conductor 4, which is inserted into the slot 2, from the rotor 3 which is at ground potential. The slot-insulating means 1 contains two identical insulating ducts 5 and 6 which are of L-shaped angled design and whose duct bottoms 7, 8, which form the base of the L, are each mounted in the region of the slot base 9.

The insulating ducts are produced from an insulating material which is essentially built up in layers and has a material thickness, typically one millimeter, which is predetermined by the dielectric and mechanical properties of the slot-insulating means 1. The bottom 7 of the insulating duct 5 is mounted on the slot base 9, while a duct wall 10, which is adjoined thereto and forms the vertical limb of the L, fits closely against that slot wall which bounds the slot 2 to the left. The duct bottom 8 of the insulating duct 6 is mounted on the bottom 7 of the insulating duct 5. A flexible duct wall 11, which adjoins the duct bottom 8 and forms the vertical limb of the L, fits closely against that slot wall which bounds the slot 2 to the right. Since the duct walls 10, 11 are flexible, they are able to conform to any desired contours of the slot wall, irrespective of whether they are steps or angled portions.

The conductor 4, which is electrically insulated from the grounded rotor 3 by means of the two insulating ducts 5 and 6 and is secured by a slot seal (not illustrated) fixes the two insulating ducts 5 and 6 in the slot. A respective insert 12 or 13 made of a flexurally rigid material is provided in each of the two duct bottoms 7 and 8. Each of the two inserts is guided via a radius 14 or 15 into the lower part of the duct wall 10 or 11 of the insulating duct 5 or 6.

As can be seen from FIG. 2, the insulating duct is built up in layers and has two layers 16, 17 of flexible insulating material with a thickness of approximately 0.18 mm for example, which layers form the duct bottom 8 and the duct wall 11. As insulating material use is preferably made of a paper which is resistant to high temperature, contains fibers and/or flock and is based on an aromatic polymer, in particular on polyamide, for example a synthetic paper commercially available under the trade name Nomex®. The reinforcing insert 13 is provided between the two paper layers 16, 17. In order to support the current conductor 4 securely on the slot base, unlike the layers 16 and 17 the insert is of rigid design and has a thickness of, for example, 0.2 to 0.5 mm. The insert is advantageously formed from a fiber-reinforced synthetic material, for example a polyester or epoxide reinforced by a single- or multi-layered glass cloth or glass mat.

The insert 13 is guided via the radius 15 into that lower part of the duct wall 11 which adjoins the duct bottom 8. This prevents parts of the L-shaped insulating duct 6, which are not reinforced by the insert 13, from being shifted by the centrifugal force 8 out of the region of the radius 15 into the upper part of the slot 2, i.e. outward, during operation of the rotating machine. This avoids damage to the slot-insulating means 1 even after a long operating period and reliable operation of the rotating machine is ensured over the long term.

In the duct wall 11, the reinforcing insert 13 is adjoined by an insert 18 which is made of flexible insulating material, consists of the same material as the layers 16 and 17 and has approximately the same thickness, for example 0.25 mm, as the insert 13. The insert 18 improves the mechanical and dielectric properties of the duct wall 11. Furthermore, an insert 19 made of flexible insulating material is provided between the two layers 16 and 17. This material is electrically superior, but mechanically less highly stressable than the material of the layers 16 and 17 and of the insert 18. It preferably contains a polyimide and is used in the form of a film having a thickness of typically 0.1 mm. The layers 16 and 17 protect this insert against external influences caused, in particular, by mechanical forces.

The insulating duct built up in this manner has been tested at the duct bottom 8, at the join between the inserts 13 and 18 and at the duct wall 11 above the join for electric strength by being subjected to an alternating voltage of 50 Hz. It turns out that at the three abovementioned points the electric strength is, without exception, greater than 20 kV/mm and is therefore at a value which is twice as high as is usually demanded.

The insulating ducts 5 and 6 are produced in a pressing mold, which impresses the L shape, by bonding of the individual layers and inserts using a hot-curing resin, for example an epoxide. Insertion of the two ducts 5 and 6 into the slot 2 enables the slot-insulating means 1 to be produced in an extremely cost-effective manner. Since the flexible design of the duct walls 10, 11 means that they can be adapted to virtually any desired slot shape, irrespective of whether it is of angled or stepped design, slot-insulating means of any desired geometrical configuration can be produced using a single type of L-shaped insulating ducts. In this connection, it is particularly advantageous in terms of production that the width of the bottoms 7, 8 of the insulating ducts 5, 6 can be cut to the slot width, for example by sawing, cutting or punching, prior to the insertion into the slot 2. A multiplicity of slot-insulating means having different widths and different profiles can thus be manufactured from identically designed insulating ducts which have been produced in just one single pressing mold.

List of Reference Numerals

| | |
|---|---|
| 1 | Slot-insulating means |
| 2 | Slot |
| 3 | Rotor |
| 4 | Current conductor |
| 5, 6 | Insulating ducts |
| 7, 8 | Duct bottoms |
| 9 | Slot base |
| 10, 11 | Duct walls |
| 12, 13 | Inserts |
| 14, 15 | Radii |
| 16, 17 | Layers made of insulating material |
| 18 | Insert made of insulating material |
| 19 | Film made of insulating material |

1. An insulating duct (5, 6) made of a material which is built up in layers and is shaped in the manner of an L, in which the base of the L, which serves as the duct bottom (7, 8), is rigid and that limb of the L which serves as the duct wall (10, 11) is of flexible design, characterized in that a reinforcing insert (12, 13) is placed into the duct bottom (10, 11) and is guided into that part of the duct wall (10, 11) which adjoins the duct bottom (7, 8).

2. The duct as claimed in claim 1, characterized in that the material comprises at least two layers (16, 17) which are made of flexible insulating material, are provided in the duct bottom (7, 8) and in the duct wall (10, 11) and between which the reinforcing insert (12, 13) is provided.

3. The duct as claimed in claim 2, characterized in that an insert (18) which is made of flexible insulating material and adjoins the reinforcing insert (13) is provided in the duct wall (10, 11).

4. The duct as claimed in one of claims 1 to 3, characterized in that a further layer (19) which is made of a flexible insulating material of an electrically superior, but mechanically less highly stressable material is provided between the at least two layers (16, 17) made of flexible insulating material.

5. A method for producing an insulating means (1) which is inserted into a slot (2), characterized in that from a multiplicity of insulating ducts (5, 6) according to one of claims 1 to 4 having the same geometrical dimensions and a duct-bottom width which is larger than the slot bottom (9), first of all the duct bottoms of two insulating ducts are cut to length and then the cut-to-length insulating ducts (5, 6) are inserted into the slot (2) forming a U-shaped insulating duct.
